(19) United States
(12) Patent Application Publication
(10) Pub. No.: US 2014/0326657 A1
(43) Pub. Date: Nov. 6, 2014

(54) SEMI-PERMEABLE FILM, MEMBRANE INCLUDING THE SEMI-PERMEABLE FILM, AND METHOD OF MANUFACTURING THE SEMI-PERMEABLE FILM

(71) Applicant: SAMSUNG ELECTRONICS CO., LTD., Suwon-Si (KR)

(72) Inventors: Hyo KANG, Seoul (KR); Jun Hyuk MOON, Daejon (KR); Sung Soo HAN, Hwaseong-si (KR)

(73) Assignee: SAMSUNG ELECTRONICS CO., LTD., Suwon-Si (KR)

(21) Appl. No.: 14/205,563

(22) Filed: Mar. 12, 2014

(30) Foreign Application Priority Data
May 6, 2013 (KR) 10-2013-0050903

(51) Int. Cl. B01J 39/18; B01D 61/00; B01D 67/00; B01D 69/12; B01D 69/14; B01D 71/70

(52) U.S. Cl. CPC B01J 39/185; B01D 69/141; B01D 71/70; B01D 67/0006; B01D 69/125; B01D 61/002; B01D 2323/30; B01D 2323/40; B01D 2325/02; B01D 2325/04
USPC 210/490; 521/27

(57) ABSTRACT

The present disclosure pertains to a semi-permeable film including a polyhedron oligomer silsesquioxane derivative dispersed in a polymer matrix, a method of manufacturing the same, a separation membrane including the semi-permeable film, and a water treatment device including the separation membrane.

### CROSS-REFERENCE TO RELATED APPLICATION

This application claims priority under 35 U.S.C. §119 to Korean Patent Application No. 10-2013-0050903, filed in the Korean Intellectual Property Office on May 6, 2013, the entire contents of which are incorporated herein by reference.

### BACKGROUND

1. Field

The present disclosure relates to a semi-permeable film including nano-particles and having improved water reflux and salt rejection properties, a method of manufacturing the same, and a separation membrane including the semi-permeable film.

2. Description of the Related Art

In order to acquire fresh water or gray water from sea water or sewage and waste water, floating or dissolved components should be removed in conformity with the standards for drinking water. At present, reverse osmosis is widely used as a water treatment method for desalinating or making gray water out of sea water or sewage and waste water.

According to the water treatment method using a reverse osmotic membrane, a pressure corresponding to an osmotic pressure caused by the dissolved component is applied to the raw water to separate a dissolved component, such as a base (NaCl), from water. For example, the concentration of the salt dissolved in sea water ranges from about 30,000 to about 45,000 ppm and the osmotic pressure caused by the concentration ranges from about 20 to about 30 atm. As a result, a pressure of about 20 to 30 atm or higher is applied to the raw water to produce fresh water from the raw water. Generally, an energy amount of about 6 to about 10 kW is required to produce about 1 m³ of fresh water from sea water.

Recently, an energy recollection device has been developed and applied to save the energy consumed for a reverse osmosis process. However, in this case, about 3 kW of energy is required to drive a motor of a high-pressure pump for the device.

A water treatment process based on forward osmosis has recently been suggested as an alternative. The forward osmosis process is economical compared with the reverse osmosis process, because the forward osmosis process does not require pressure but uses a natural osmosis phenomenon. Therefore, researchers are actively studying the development of the forward osmosis process.

### SUMMARY

Some example embodiments of the present disclosure relate to a semi-permeable film having increased selectivity and permeability.

Some example embodiments of the present disclosure relate to a separation membrane including the semi-permeable film and having improved salt rejection and water reflux.

Some example embodiments of the present disclosure relate to a method of manufacturing the semi-permeable film.

Some example embodiments of the present disclosure relate to a water treatment device including the separation membrane.

According to one example embodiment of the present disclosure, a semi-permeable film may include a polyhedron oligomer silsesquioxane derivative dispersed in a polymer matrix. The polyhedron oligomer silsesquioxane derivative may be configured to permeate water while not permeating a salt.

An atomic ratio of Si to O forming a polyhedron lattice of the polyhedron oligomer silsesquioxane derivative may range from about 1:1 to about 1.5:1.

The polyhedron oligomer silsesquioxane derivative may be a pentahedron represented by the following Chemical Formula 1, a hexahedron represented by the following Chemical Formula 2, a heptahedron represented by the following Chemical Formula 3, an octahedron represented by the following Chemical Formula 4, an enneahedron represented by the following Chemical Formula 5, or a decahedron represented by the following Chemical Formula 6. The polyhedron oligomer silsesquioxane derivative may be an open polyhedron where O in at least one —Si—O—Si— bond of the above Chemical Formulae 1 to 6 is substituted with a substituent and the bond is cleaved.

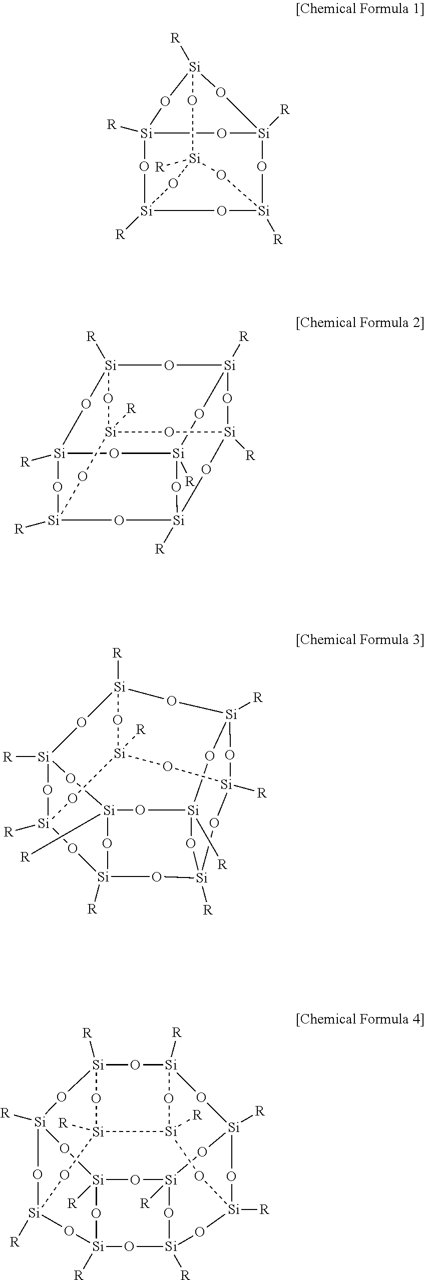

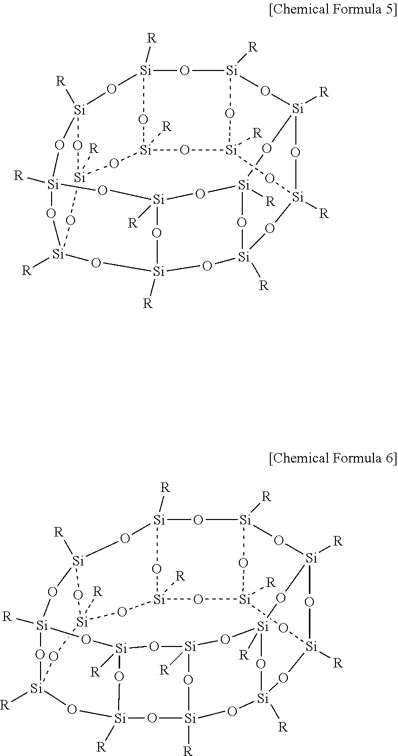

In the above Chemical Formulae 1 to 6, R's are the same or different, and are independently an ionic functional group, a non-ionic functional group, an oligomer, a polymer, a functional group modified with an inorganic particle, or a combination thereof.

The ionic functional group may be an anionic functional group selected from —COO⁻, —CO₃⁻, —SO⁻₃, —SO₂⁻, —SO₂NH⁻, —NH₂⁻, —PO₃⁻², —PO₄⁻, —CH₂OPO₃⁻, —(CH₂O)₂PO₂⁻, —C₆H₄O⁻, —OSO₃⁻, —SO₂NR′⁻, —SO₂NSO₂R′⁻, —SO₂CRSO₂R″⁻, —AsO₃⁻, —SeO₃⁻ (wherein R′ and R″ are each independently a C1 to C4 alkyl group or a C7 to C10 arylalkyl group), —Cl⁻, —Br⁻, —SCN⁻, —ClO⁴⁻, and a combination thereof; a cationic functional group selected from an amino group, an ammonium group, a quaternary phosphonium group (—PR′″₄), a tertiary sulfonium group (—SR′″₃), a pyridinium group, a piperidine group, a pyrimidinium group, a pyrazolidine group, a piperazine group, and a combination thereof (wherein R′″ is a C1 to C4 alkyl or a C7 to C10 arylalkyl group); or a zwitterionic functional group such as imidazolidine, betaine, or morpholine.

The non-ionic functional group may be selected from a substituted or unsubstituted C1-C30 alkyl, a substituted or unsubstituted C2-C30 alkenyl, a substituted or unsubstituted C2-C30 alkynyl, a substituted or unsubstituted C5 to C30 aryl, a substituted or unsubstituted C3-C30 cycloalkyl, a substituted or unsubstituted C1-C30 heterocycloalkyl, a substituted or unsubstituted C1-C30 heteroaryl, a substituted or unsubstituted C2-C30 alkylaryl, a substituted or unsubstituted C2-C30 arylalkyl, a substituted or unsubstituted C1-C30 alkoxy, a substituted or unsubstituted ester, a substituted or unsubstituted ether, and a combination thereof.

The oligomer or polymer may be a hydrophilic oligomer of alkylene oxide, vinyl alcohol, acrylonitrile, vinylpyrrolidone, lactic acid, epoxy, cellulose, (meth)acrylate, or alkyl(meth)acrylic acid, and the like, or a polymer thereof.

The oligomer or polymer may be a hydrophobic oligomer or polymer.

The functional group modified with an inorganic particle may be a C1 to C30 alkylsilyl group, and the like.

The functional group may be a tetramethyl ammonium (TMA) group or an isobutyl group.

The polyhedron oligomer silsesquioxane derivative may be a polyhedron oligomer silsesquioxane where 1 to 16 of R's linked to Si in the above Chemical Formula 1 to 6 may be substituted with the ionic functional group, non-ionic functional group, oligomer, polymer, or functional group modified with an inorganic particle, or a combination thereof.

A particle of the polyhedron oligomer silsesquioxane derivative may be a nano-particle including nano-pores having an average pore size of about 0.3 nm to about 3 nm.

A particle of the polyhedron oligomer silsesquioxane derivative may be dispersed in the polymer matrix of the semi-permeable film.

The polymer matrix may include a polymer selected from polyamide, cross-linked polyamide, polyamide-hydrazide, poly(amide-imide), polyimide, poly(allylamine)hydrochloride/poly(sodium styrene sulfonate) (PAH/PSS), polybenzimidazole, sulfonated poly(arylene ether sulfone), and a combination thereof.

The semi-permeable film may be manufactured by mixing the polyhedron oligomer silsesquioxane derivative particles and monomers for preparing the polymer matrix and polymerizing the monomer to form the polymer matrix.

When the polymer matrix is a polyamide, the polyamide may be a polymer of a first monomer of a polyamine and a second monomer of a multi-functional acylhalide.

The first monomer may be selected from a C6 to C30 aromatic polyamine, a C1 to C30 aliphatic polyamine, and a combination thereof.

Examples of the C6 to C30 aromatic polyamine may be diaminobenzene, triaminobenzene, m-phenylene diamine, p-phenylene diamine, 1,3,5-triaminobenzene, 1,3,4-triaminobenzene, 3,5-diaminobenzoic acid, 2,4-diaminotoluene, 2,4-diaminoanisole, xylylene diamine, and a combination thereof.

Examples of the C1 to C30 aliphatic polyamine may be ethylene diamine, propylene diamine, piperazine, tris(2-diaminoethyl)amine), and a combination thereof.

The second monomer of the multi-functional acylhalide may be selected from trimesoyl chloride (TMC), trimellitic chloride, isophthaloyl chloride, terephthaloyl chloride, and a combination thereof.

In another example embodiment of the present disclosure, a method of manufacturing the semi-permeable film is provided.

The method of manufacturing the semi-permeable film may include preparing a first monomer solution for the polymer matrix; preparing a second monomer solution for the polymer matrix; adding the polyhedron oligomer silsesquioxane derivative to the first monomer solution, the second monomer solution, or both the first monomer solution and the second monomer solution; and contacting the first monomer solution with the second monomer solution on a substrate to carry out interface polymerization.

The first monomer solution may be prepared by dissolving the first monomer in a first solvent.

The second monomer solution may be prepared by dissolving the second monomer in a second solvent.

The first solvent and second solvent may be immiscible with respect to each other.

In one example embodiment, the first solvent may be a polar solvent selected from water, acetonitrile, dimethylformamide and a mixture thereof, and the second solvent may be a nonpolar solvent selected from C5 to C30 aliphatic hydrocarbon (e.g., hexane, decane, and the like), C5 to C10 aromatic hydrocarbon (e.g., xylene, toluene, and the like), dimethylsulfoxide, dimethylacrylamide, methylpyrrolidone and a mixture thereof.

Since the polyhedron oligomer silsesquioxane derivative has a negative surface charge, it may be dispersed in a solution including a nonpolar solvent.

Before mixing the polyhedron oligomer silsesquioxane derivative with the first monomer solution or second monomer solution, the polyhedron oligomer silsesquioxane derivative is added to the first solvent or the second solvent and treated with ultrasonic waves, agitated, or the like, and the resultant dispersion is added to the first monomer solution or the second monomer solution so that the polyhedron oligomer silsesquioxane derivative particles are well dispersed. The substrate may be a glass plate, or a woven or non-woven fabric made of a polymer fiber. The woven or non-woven fabric may be included in the separation membrane as a support of the semi-permeable film.

The contacting process of the first monomer solution with the second monomer solution on a substrate to carry out interface polymerization may include coating the first monomer solution on the substrate, coating the second monomer solution on the substrate coated with the first monomer solution, and interface polymerizing the first monomer and second monomer.

Coating processes of the first monomer solution and second monomer solution are not particularly limited, but may be for example a dipping process, spin casting, wet spinning, and the like.

After completing the interface polymerization of the first monomer and second monomer, the polymer is dipped and washed in water at about 90° C. to about 100° C. to manufacture the semi-permeable film.

The semi-permeable film may be applied to a water treatment separation membrane.

In another example embodiment, a separation membrane including the semi-permeable film is provided.

The separation membrane may further include a porous support, and the semi-permeable film may be disposed on the porous support.

The porous support may include a polymer selected from a polysulfone-based polymer such as polysulfone, polyethersulfone, poly(ether sulfone ketone) and the like; a poly(meth)acrylonitrile polymer such as polyacrylonitrile, polymethacrylonitrile, and the like; a polyolefin-based polymer such as polyethylene, polypropylene, polystyrene, and the like; a polycarbonate; a polyalkylene terephthalate such as polyethylene terephthalate, polybutylene terephthalate, and the like; a polyimide-based polymer; a polybenzimidazole-based polymer; a polybenzthiazole-based polymer; a polybenzoxazole-based polymer; a polyepoxy-based polymer; a polyphenylenevinylene-based polymer; a polyamide-based polymer; a cellulose-based polymer; polyvinylidene fluoride (PVDF); polytetrafluoroethylene (PTFE); polyvinyl chloride (PVC), and a combination thereof.

The polyhedron oligomer silsesquioxane derivative may be included in an amount of about 0.01 to about 10 wt %, and specifically about 0.1 to about 5 wt %, based on the total weight of the polymer matrix of the semi-permeable film.

When the polyhedron oligomer silsesquioxane derivative is included in the semi-permeable film within the above range, salt rejection and water reflux of the semi-permeable film may be improved.

The semi-permeable film may have a thickness of about 0.01 to about 100 μm, specifically about 0.02 to about 50 μm, and more specifically about 0.03 to about 10 μm.

Within the above thickness ranges, the separation membrane including the semi-permeable film may have improved salt rejection and water reflux.

The porous support may have a thickness of about 25 to about 250 μm. Within the above thickness ranges, appropriate strength of a separation membrane may be obtained while maintaining the water reflux.

Tiny pores may be present at the contact part between the semi-permeable film and the porous support.

The semi-permeable film may act as an active layer for a separation function of a membrane, and the porous support may act as a support layer.

The separation membrane including the semi-permeable film may be used as a water treatment separation membrane.

The water treatment separation membrane may be a microfiltration membrane, an ultrafiltration membrane, a nanofiltration membrane, a reverse osmotic membrane, or a forward osmosis membrane, depending on the desired use(s).

The water treatment separation membrane may be used in various water treatment devices. For example, it may be used in a reverse osmosis water treatment device, without limitation.

The water treatment device may be used for, for example, purification treatment, waste water treatment and reuse, and desalination of sea water.

### BRIEF DESCRIPTION OF THE DRAWINGS

FIG. 1 is a schematic view showing a structure and a pore diameter of a polyhedron oligomer silsesquioxane derivative and a water passing path through the pores according to one example embodiment of the present disclosure.

FIG. 2 shows scanning electron microscope (SEM) photographs of a cross-section and a surface ((a) and (b)) of a polyamide/polysulfone (PA/PS) membrane, a cross-section and a surface ((c) and (d)) of a polyamide-octatetramethyl ammonium POSS 5/polysulfone (PA-octatetramethyl ammonium POSS 5/PS) membrane, and a cross-section and a surface ((e) and (f)) of a polyamide-octaisobutyl POSS 5/polysulfone (PA-octaisobutyl POSS 5/PS) membrane.

### DETAILED DESCRIPTION

This disclosure will be described more fully hereinafter in the following detailed description, in which some example embodiments of this disclosure are described. However, this disclosure may be embodied in many different forms and should not be construed as limited to the example embodiments set forth herein.

It will be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, e.g., “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms, “comprises,” “comprising,” “includes,” and/or “including,” if used herein, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing.

Unless otherwise defined, all terms (including technical and scientific terms) used herein have the same meaning as commonly understood by one of ordinary skill in the art. It will be further understood that terms, including those defined in commonly used dictionaries, should be interpreted as having a meaning that is consistent with their meaning in the context of the relevant art and will not be interpreted in an idealized or overly formal sense unless expressly so defined herein.

As used herein, when a definition is not otherwise provided, the term “substituted” may refer to one substituted with a halogen (F, Cl, Br, or I), a hydroxy group, a nitro group, a cyano group, an imino group (═NH or ═NR′, where R′ is a C1 to C10 alkyl group), an amino group (—NH₂, —NH(R″), or —N(R′″)(R″″), where R″ to R″″ are each independently a C1 to C10 alkyl group), an amidino group, a hydrazine group, a hydrazone group, a carboxyl group, a C1 to C30 alkyl group, a C1 to C30 alkylsilyl group, a C3 to C30 cycloalkyl group, C2 to C30 heterocycloalkyl group, a C6 to C30 aryl group, a C2 to C30 heteroaryl group, a C1 to C30 alkoxy group, or a C1 to C30 fluoroalkyl group.

As used herein, when a definition is not otherwise provided, the prefix “hetero” may refer to one including 1 to 3 heteroatoms selected from N, O, S, and P, with the remaining structural atoms in a compound or a substituent being carbon atoms.

As used herein, when a definition is not otherwise provided, the term “combination thereof” refers to at least two substituents bound to each other by a linker, or at least two substituents condensed to each other.

As used herein, when a definition is not otherwise provided, the term “alkyl group” may refer to a “saturated alkyl group” without an alkenyl group or an alkynyl group, or an “unsaturated alkyl group” including at least one of an alkenyl group or an alkynyl group. The term “alkenyl group” may refer to a substituent in which at least two carbon atoms are bound with at least one carbon-carbon double bond, and the term “alkynyl group” refers to a substituent in which at least two carbon atoms are bound with at least one carbon-carbon triple bond. The alkyl group may be a branched, linear, or cyclic alkyl group.

The alkyl group may be a C1 to C20 alkyl group, and more specifically a C1 to C6 alkyl group, a C7 to C10 alkyl group, or a C11 to C20 alkyl group.

For example, a C1-C4 alkyl may have 1 to 4 carbon atoms, and may be selected from methyl, ethyl, propyl, iso-propyl, n-butyl, iso-butyl, sec-butyl, and t-butyl.

Examples of the alkyl group include a methyl group, an ethyl group, a propyl group, an isopropyl group, a butyl group, an isobutyl group, a t-butyl group, a pentyl group, a hexyl group, an ethenyl group, a propenyl group, a butenyl group, a cyclopropyl group, a cyclobutyl group, a cyclopentyl group, a cyclohexyl group, and the like.

The term “aromatic group” may refer to a substituent including a cyclic structure where all elements have p-orbitals which form conjugation. Examples include an aryl group and a heteroaryl group.

The term “aryl group” may refer to a monocyclic or fused ring-containing polycyclic (i.e., rings sharing adjacent pairs of carbon atoms) groups.

The “heteroaryl group” may refer to one including 1 to 3 heteroatoms selected from N, O, S, or P in an aryl group, with the remaining structural atoms being carbons. When the heteroaryl group is a fused ring, each ring may include 1 to 3 heteroatoms.

According to one example embodiment of the present disclosure, a semi-permeable film may include a polyhedron oligomer silsesquioxane derivative dispersed in a polymer matrix. The polyhedron oligomer silsesquioxane derivative may be configured to permeate water while not permeating a salt. For instance, the polyhedron oligomer silsesquioxane derivative may be configured to exclude a salt.

An atomic ratio of Si to O forming a polyhedron lattice of the polyhedron oligomer silsesquioxane derivative may range from about 1:1 to about 1.5:1.

The polyhedron oligomer silsesquioxane derivative may be a pentahedron represented by the following Chemical Formula 1, a hexahedron represented by the following Chemical Formula 2, a heptahedron represented by the following Chemical Formula 3, an octahedron represented by the following Chemical Formula 4, an enneahedron represented by the following Chemical Formula 5, or a decahedron represented by the following Chemical Formula 6. The polyhedron oligomer silsesquioxane derivative may be an open polyhedron where O in at least one —Si—O—Si— bond of the above Chemical Formulae 1 to 6 is substituted with a substituent and the bond is cleaved.

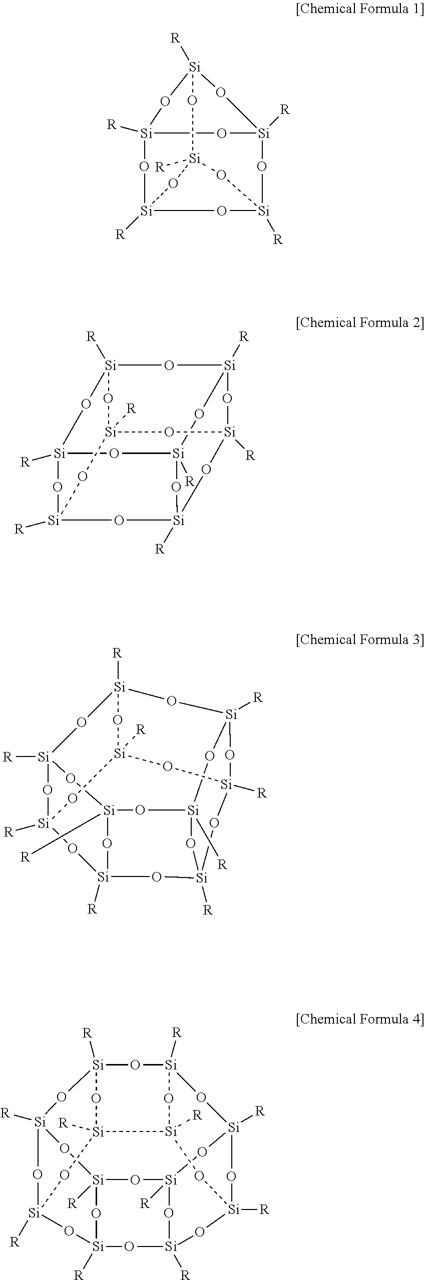

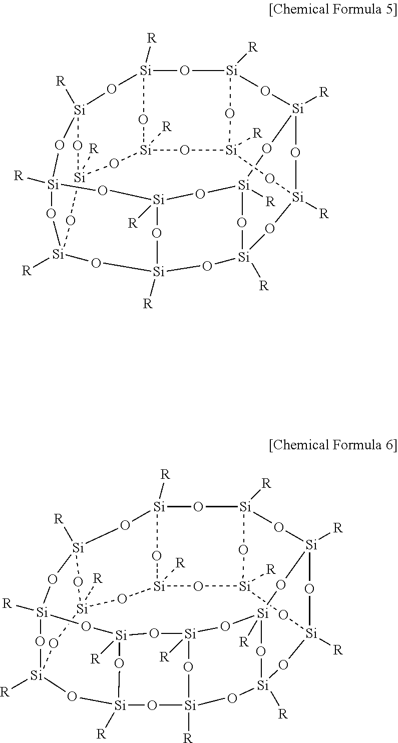

In the above Chemical Formulae 1 to 6, R's may be the same or different, and may be independently an ionic functional group, a non-ionic functional group, an oligomer, a polymer, or a functional group modified with an inorganic particle, or a combination thereof.

The ionic functional group may be an anionic functional group selected from —COO⁻, —CO₃⁻, —SO⁻₃, —SO₂⁻, —SO₂NH⁻, —NH₂⁻, —PO₃⁻², —PO₄⁻, —CH₂OPO₃⁻, —(CH₂O)₂PO₂⁻, —C₆H₄O⁻, —OSO₃⁻, —SO₂NR′⁻, —SO₂NSO₂R′⁻, —SO₂CRSO₂R″⁻, —AsO₃⁻, —SeO₃⁻(wherein R′ and R″ are each independently a C1 to C4 alkyl or a C7 to C10 arylalkyl group), —Cl⁻, —Br⁻, —SCN⁻, —ClO⁴⁻, and a combination thereof; a cationic functional group selected from an amino group, an ammonium group, a quaternary phosphonium group (—PR′″₄), a tertiary sulfonium group (—SR′″₃), a pyridinium group, a piperidine group, a pyrimidinium group, a pyrazolidine group, a piperazine group, and a combination thereof (wherein R is a C1 to C4 alkyl or a C7 to C10 arylalkyl group); or a zwitterionic functional group such as imidazolidine, betain, or morpholine.

The non-ionic functional group may be selected from a substituted or unsubstituted C1-C30 alkyl, a substituted or unsubstituted C2-C30 alkenyl, a substituted or unsubstituted C2-C30 alkynyl, a substituted or unsubstituted C5 to C30 aryl, a substituted or unsubstituted C3-C30 cycloalkyl, a substituted or unsubstituted C1-C30 heterocycloalkyl, a substituted or unsubstituted C1-C30 heteroaryl, a substituted or unsubstituted C2-C30 alkylaryl, a substituted or unsubstituted C2-C30 arylalkyl, a substituted or unsubstituted C1-C30 alkoxy, a substituted or unsubstituted ester, a substituted or unsubstituted ether, and a combination thereof.

The oligomer or polymer may be a hydrophilic oligomer of alkylene oxide, vinyl alcohol, acrylonitrile, vinylpyrrolidone, lactic acid, epoxy, cellulose, (meth)acrylate, or alkyl(meth)acrylic acid, and the like, or a polymer thereof.

The oligomer or polymer may be a hydrophobic oligomer or polymer.

The functional group modified with an inorganic particle may be a C1 to C30 alkylsilyl group, and the like.

The polyhedron oligomer silsesquioxane derivative may be a polyhedron oligomer silsesquioxane where 1 to 16 of R's linked to Si in the above Chemical Formula 1 to 6 may be substituted with the ionic functional group, non-ionic functional group, oligomer, polymer, or functional group modified with an inorganic particle, or a combination thereof.

A particle of the polyhedron oligomer silsesquioxane derivative may be a nano-particle including nano-pores having an average pore size of about 0.3 nm to about 3 nm depending on the number of Si of the polyhedron.

A particle of the polyhedron oligomer silsesquioxane derivative may be dispersed in the polymer matrix of the semi-permeable film.

The polymer matrix may be any well-known polymer matrix used for manufacturing a semi-permeable film without limitation. The polymer matrix may include a polymer selected from, for example, a polyamide, a cross-linked polyamide, a polyamide-hydrazide, a poly(amide-imide), a polyimide, poly(allylamine)hydrochloride/poly(sodium styrene sulfonate) (PAH/PSS), polybenzimidazole, a sulfonated poly(arylene ether sulfone), and a combination thereof, but is not limited thereto.

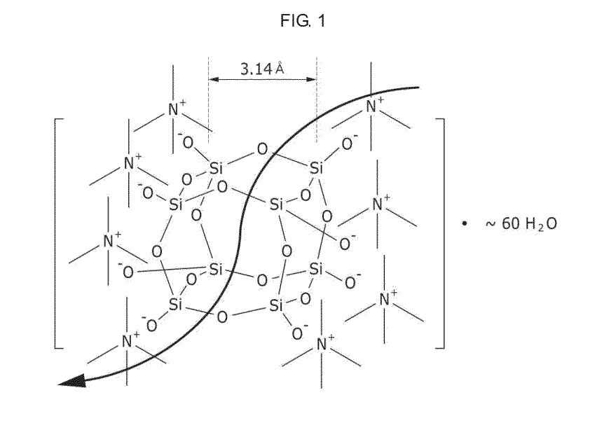

FIG. 1 is a schematic view showing a molecular structure and a pore diameter of the polyhedron oligomer silsesquioxane (hereinafter, referred to as ‘POSS’) derivative of the above Chemical Formula 2 along with water molecules passing through the pores.

As shown in the schematic view, the POSS derivative is dispersed in the polymer matrix and includes nano-sized pores, and thus increases the water permeation amount but suppresses or precludes permeation of salt ions of hydrated Na⁺, Cl⁻, K⁺, Mg²⁺, Ca²⁺, Li⁺, and the like.

An attempt to increase the water permeation has been made by introducing a porous inorganic compound such as zeolite into a separation layer of a water treatment separation membrane or an inorganic nano-particle such as SiO₂ and TiO₂ therein in order to provide hydrophilicity for the separation layer.

However, the inorganic compound such as zeolite has a size of tens of to hundreds of nano meters, and thus a problem of increasing water reflux but decreasing a salt rejection rate occurs.

On the other hand, the inorganic nano-particle has a non-porous structure and thus may not decrease the effective thickness of a separation membrane and not greatly increase the water reflux or salt rejection rate.

According to an example embodiment of the present disclosure, the POSS derivative includes pores in a molecular structure but is negatively charged, and thus is hydrophilic and porous. However, the POSS derivative increases both water reflux and salt rejection rate despite substitution with a hydrophilic or hydrophobic functional group for the substituent R. In addition, the POSS derivative may have higher water permeability and salt rejection rate when a hydrophobic functional group is substituted in a smaller amount than that of a hydrophilic functional group.

Therefore, the effect relates to a nano-sized pore structure of the POSS derivative, interactions between a substituent R of the derivative and a POSS particle, and structures and operation of the POSS derivative in a polymer matrix, as well as hydrophilicity of negatively-charged surface of the POSS derivative, without being bound to a specific theory. Specifically, this POSS derivative increases free volume of a polymer in a polymer matrix, and thus, the free volume may be adjusted by using a substituent R of the POSS derivative to increase water reflux and salt rejection rate of the polymer matrix. In addition, as post-described, the POSS particle increases hydrophilic characteristics of a film when the film is manufactured by including the POSS derivative in the polymer matrix.

The semi-permeable film may be manufactured by mixing the POSS derivative and monomers for preparing the polymer matrix, and polymerizing the monomers to form the polymer matrix.

For example, when the polymer matrix is a polyamide, the polyamide may be a polymer of a first monomer of a polyamine and a second monomer of a multi-functional acylhalide.

The first monomer may be selected from a C6 to C30 aromatic polyamine, a C1 to C30 aliphatic polyamine, and a combination thereof.

Examples of the C6 to C30 aromatic polyamine may be diaminobenzene, triaminobenzene, m-phenylene diamine, p-phenylene diamine, 1,3,5-triaminobenzene, 1,3,4-triaminobenzene, 3,5-diaminobenzoic acid, 2,4-diaminotoluene, 2,4-diaminoanisole, xylylene diamine, and a combination thereof.

Specific examples of the C1 to C30 aliphatic polyamine may be ethylene diamine, propylene diamine, piperazine, tris(2-diaminoethyl)amine, and a combination thereof.

The second monomer of the multi-functional acylhalide may be selected from trimesoyl chloride (TMC), trimellitic chloride, isophthaloyl chloride, terephthaloyl chloride, and a combination thereof.

The polymer matrix may be prepared with relative ease by appropriately selecting well-known monomers using a well-known method in this art.

A method of manufacturing the semi-permeable film may include preparing a first monomer solution for the polymer matrix; preparing a second monomer solution for the polymer matrix; adding the polyhedron oligomer silsesquioxane derivative to the first monomer solution, the second monomer solution, or both the first monomer solution and the second monomer solution; and contacting the first monomer solution with the second monomer solution on a substrate to carry out interface polymerization.

In an example embodiment, the method of manufacturing the semi-permeable film may include dissolving a first monomer in a first solvent to prepare the first monomer solution, dissolving a second monomer in a second solvent to prepare the second monomer solution, adding the polyhedron oligomer silsesquioxane (POSS) derivative to either one of the first monomer solution and the second monomer solution or both of them, coating the first monomer solution on a substrate, and coating the second monomer solution on the substrate coated with the first monomer solution to carry out interface polymerization of the first monomer and the second monomer. The first solvent and second solvent may be immiscible with respect to each other.

The first solvent may be a polar solvent selected from water, acetonitrile, dimethylformamide, and a mixture thereof, and the second solvent may be a nonpolar solvent selected from a C5 to C30 aliphatic hydrocarbon (e.g., hexane, decane, and the like), a C5 to C10 aromatic hydrocarbon (e.g., xylene, toluene, and the like), dimethylsulfoxide, dimethylacrylamide, methylpyrrolidone, and a mixture thereof.

Since the polyhedron oligomer silsesquioxane derivative has a negative surface charge, it may be dispersed in a solution including a nonpolar solvent.

Before mixing the polyhedron oligomer silsesquioxane derivative with the first monomer solution or second monomer solution, the polyhedron oligomer silsesquioxane derivative is added to the first solvent or the second solvent and treated with ultrasonic waves, or is agitated and the like, and the resultant dispersion is added to the first monomer solution or the second monomer solution so that the polyhedron oligomer silsesquioxane derivative particle is well dispersed.

The substrate may be a glass plate, or a woven or non-woven fabric made of a polymer fiber, but is not limited thereto. The woven or non-woven fabric may be included in the separation membrane as a support of the semi-permeable film.

Coating processes of the first monomer solution and second monomer solution on the substrate are not particularly limited, but may be for example include a dipping process, spin casting, wet spinning, and the like.

After completing the interface polymerization of the first monomer and second monomer, the polymer is dipped and washed in water at about 90° C. to about 100° C. to manufacture the semi-permeable film.

The semi-permeable film may be applied to a water treatment separation membrane.

Therefore, in another example embodiment, a separation membrane may include the semi-permeable film.

The separation membrane may further include a porous support, and the semi-permeable film may be disposed on the porous support and function as an active layer.

The porous support may include a polymer selected from a polysulfone-based polymer such as polysulfone, polyethersulfone, poly(ethersulfoneketone) and the like; a poly(meth)acrylonitrile polymer such as polyacrylonitrile, polymethacrylonitrile, and the like; a polyolefin-based polymer such as polyethylene, polypropylene, polystyrene, and the like; a polycarbonate; a polyalkylene terephthalate such as polyethylene terephthalate, polybutylene terephthalate, and the like; a polyimide-based polymer; a polybenzimidazole-based polymer; a polybenzthiazole-based polymer; a polybenzoxazole-based polymer; a polyepoxy-based polymer; a polyphenylenevinylene-based polymer; a polyamide-based polymer; a cellulose-based polymer; polyvinylidene fluoride (PVDF); polytetrafluoroethylene (PTFE); polyvinyl chloride (PVC); and a combination thereof.

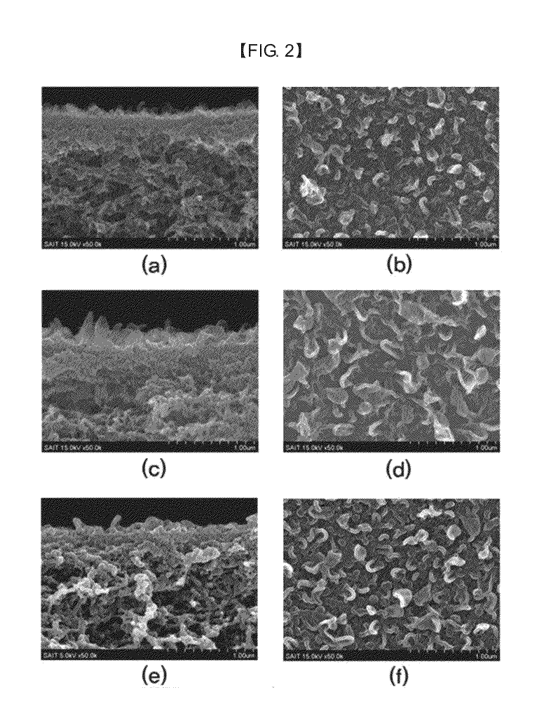

Scanning electron microscope (SEM) photographs of a cross-section and a surface ((c) and (d) of FIG. 2) of polyamide-octatetramethyl ammonium POSS 5/polysulfone (PA-octatetramethyl ammonium POSS 5/PS), and a cross-section and a surface ((e) and (f) of FIG. 2) of polyamide-octaisobutyl POSS 5/polysulfone (PA-octaisobutyl POSS 5/PS) that are manufactured according to the method are shown along with a cross-section ((a) of FIG. 2) and a surface ((b) of FIG. 2) of polyamide/polysulfone (PA/PS) that is manufactured without a POSS derivative in a polyamide separation layer.

As shown in the photographs, the polyamide separation layer including a POSS derivative ((c) to (f) of FIG. 2) has increased roughness at the cross-section and surface compared with the cross-section and surface of the membrane including no POSS derivative.

Without being bound to a specific theory, the reason of increasing roughness of the surface and cross-section of the membrane is that the first and/or second monomers bounce farther from the interface due to the POSS particles dispersed in the first and/or second monomers when the first and second monomers forming a polymer matrix are polymerized on the interface.

In addition, the surface roughness increase makes the membrane structure like a sponge and increases the water permeation amount. In fact, a separation membrane including a film manufactured by adding a POSS derivative as shown in the examples increases water permeation amount and salt rejection rate compared with a membrane including a film manufactured by adding no POSS derivative.

The polyhedron oligomer silsesquioxane derivative may be included in an amount of about 0.01 to about 10 wt %, and specifically about 0.1 to about 5 wt %, based on the total weight of the polymer matrix of the semi-permeable film.

When the polyhedron oligomer silsesquioxane derivative is included in the semi-permeable film within the above range, salt rejection and water reflux of the semi-permeable film may be improved.

The semi-permeable film may have a thickness of about 0.01 to about 100 μm, specifically about 0.02 to about 50 μm, and more specifically about 0.03 to about 10 μm.

Within the above thickness ranges, the separation membrane including the semi-permeable film may have improved salt rejection and water reflux.

The porous support may have a thickness of about 25 to about 250 μm. Within the above thickness ranges, an appropriate strength of separation membrane may be improved while maintaining the water reflux.

Tiny pores may be present at the contact part between the semi-permeable film and the porous support.

The semi-permeable film may act as an active layer for a separation function of a membrane, and the porous support may act as a support layer.

The separation membrane including the semi-permeable film may be used as a water treatment separation membrane.

The water treatment separation membrane may be a microfiltration membrane, an ultrafiltration membrane, a nanofiltration membrane, a reverse osmotic membrane, or a forward osmosis membrane, according to uses. Such a water treatment separation membrane may be used in various water treatment devices, for example, a reverse osmosis water treatment device, a forward osmosis water treatment device, and the like, without limitation.

The water treatment device may be used for, for example, purification treatment, waste water treatment and reuse, and desalination of sea water.

Hereinafter, various embodiments are illustrated in more detail with reference to the following examples. However, it should be understood that the present disclosure is not limited thereto.

### EXAMPLES

### Example 1

A first solution is prepared by dissolving 3.4 wt % of m-phenylene diamine (MPD) and 3.5 wt % of octatetramethyl ammonium polyhedron oligomer silsesquioxane in water, and a second solution is prepared by dissolving 0.15 wt % of trimesoyl chloride (TMC) in an Isopar-E solvent. Subsequently, a polysulfone porous support is dipped in the first solution and rolled, and water droplets on the surface of the polysulfone porous support are removed to manufacture the polysulfone porous support coated with the first solution on the surface. The polysulfone porous support coated with the first solution on the surface is dipped in the second solution.

### Example 2

A separation membrane is manufactured according to the same method as Example 1, except for using 2.1 wt % of octatetramethyl ammonium polyhedron oligomer silsesquioxane.

### Example 3

A separation membrane is manufactured according to the same method as Example 1, except for using 4.8 wt % of octatetramethyl ammonium polyhedron oligomer silsesquioxane.

### Example 4

A separation membrane is manufactured according to the same method as Example 1, except for using 6.7 wt % of octatetramethyl ammonium polyhedron oligomer silsesquioxane.

### Example 5

A first solution is prepared by dissolving 3.4 wt % of m-phenylene diamine in water, and a second solution is prepared by dissolving 0.15 wt % of trimesoyl chloride and 0.1 wt % of octaisobutyl polyhedron oligomer silsesquioxane in an Isopar-E solvent. Subsequently, a polysulfone porous support is dipped in the first solution and then rolled, and water droplets on the surface of the polysulfone porous support are removed, manufacturing the polysulfone porous support coated with a first solution on the surface. The polysulfone porous support coated with the first solution on the surface is dipped in the second solution.

### Example 6

A separation membrane is manufactured according to the same method as Example 5, except for using 0.05 wt % of octaisobutyl ammonium polyhedron oligomer silsesquioxane.

### Example 7

A separation membrane is manufactured according to the same method as Example 5, except for using 0.25 wt % of octaisobutyl ammonium polyhedron oligomer silsesquioxane.

### Comparative Example 1

A first solution is prepared by dissolving 3.4 wt % of m-phenylene diamine in water, and a second solution is prepared by dissolving 0.15 wt % of trimesoyl chloride in an Isopar-E solvent. Subsequently, a polysulfone porous support is dipped in the first solution and rolled, and water droplets are removed, manufacturing the polysulfone porous support coated with the first solution on the surface. The polysulfone porous support coated with the first solution on the surface is dipped in the second solution.

Salt Rejection

The salt rejection rates of the separation membranes according to Examples 1 to 10 and Comparative Example 1 are measured, and the results are provided in the following Table 1. First of all, the separation membranes are respectively mounted in a cell having an effective area of 23.04 cm², and the cells are supplied with 35,000 ppm of a NaCl solution at room temperature (about 25° C.). Herein, the crossflow rate of the NaCl solution is 3 L/min. The separation membranes are consolidated at 55 bar for 2 hours, and the salt rejection rates of the separation membranes are measured according to the following Equation 1.

R=1−(cp/cb) [Equation 1]

In Equation 1, R denotes a salt rejection rate, cb denotes a salt concentration of a bulk feed, and cp denotes a salt concentration of permeated water.

TABLE 1

| Separation membrane | Salt rejection rate (%) |
|---|---|
| Example1 | 99.6 |
| Example2 | 99.3 |
| Example3 | 99.3 |
| Example4 | 99.1 |
| Example5 | 99.6 |
| Example6 | 99.4 |
| Example7 | 99.2 |
| Comparative Example1 | 99.0 |

Referring to Table 1, the separation membranes according to Examples 1 to 7 have higher salt rejection rates than that of the separation membrane according to Comparative Example 1.

Water Reflux

The eluting rates of the separation membranes according to Examples 1 to 7 and Comparative Example 1 are measured. First of all, the separation membranes are respectively mounted in a cell having an effective area of 23.04 cm², and the cells are supplied with 35,000 ppm of a NaCl solution at room temperature (about 25° C.). The crossflow rate of the NaCl solution is 3 L/min. The separation membranes are consolidated at 55 bar for 2 hours.

TABLE 2

| Separation membrane | Water reflux (LMH) |
|---|---|
| Example 1 | 44.6 |
| Example 2 | 38.5 |
| Example 3 | 40.0 |
| Example 4 | 44.8 |
| Example 5 | 39.5 |
| Example 6 | 38.0 |
| Example 7 | 36.5 |
| Comparative Example 1 | 33.7 |

In Table 2, LMH (L/m²·hour) refers to the water passing amount per unit time. In other words, the LMH refers to the water passing amount per 1 m² membrane, L refers to water amount (liter) passed through the membrane, M refers to the membrane area (m²), and H refers to the passing time. As shown in Table 2, the separation membranes according to Examples 1 to 7 have improved water reflux compared with that of the separation membrane according to Comparative Example 1.

Contact Angle

The contact angles of the separation membranes according to Examples 1 to 7 and Comparative Example 1 are measured. The contact angle of each membrane is measured by dripping water drops one by one, and the results are provided in the following Table 3.

TABLE 3

| Separation membrane | Contact angle (degrees) |
|---|---|
| Example1 | 35.2 |
| Example2 | 37.8 |
| Example3 | 33.4 |
| Example4 | 32.5 |
| Example5 | 39.2 |
| Example6 | 39.1 |
| Example7 | 39.1 |
| Comparative Example1 | 35.2 |

Referring to Table 3, the separation membranes according to Examples 1 to 4 have smaller contact angles than the separation membrane according to Comparative Example 1, which indicates that the separation membranes according to Examples 1 to 4 are hydrophilic. The hydrophilicity is caused by a tetramethyl ammonium group having a charge. The separation membranes including isobutyl-modified polyhedron oligomer silsesquioxane according to Examples 5 to 7 have larger contact angles than the separation membrane according to Comparative Example 1, which indicates that the separation membranes are hydrophobic.

X-Ray Photoelectron Spectroscopy

The separation membranes according to Examples 1 and 5 and Comparative Example 1 are analyzed through X-ray photoelectron spectroscopy (XPS), and the results are provided in Table 4.

TABLE 4

| Separation membrane | C1s | N1s | O1s | Si2p |
|---|---|---|---|---|
| Example 1 | 70.55 | 13.91 | 15.22 | 0.33 |
| Example 5 | 72.89 | 12.22 | 14.69 | 0.2 |
| Comparative Example 1 | 75.36 | 13.47 | 11.12 | 0.05 |

As shown in Table 4, the separation membranes according to Examples 1 and 5 include Si and O in a high amount due to POSS particles, unlike the separation membrane according to Comparative Example 1.

Inductively Coupled Plasma-Atomic Emission Spectrometry

Inductively coupled plasma-atomic emission spectrometry (ICP-AES) is used to analyze the Si amount of the separation membranes according to Examples 1 and 5 and Comparative Example 1, and the results are provided in Table 5.

TABLE 5

| | ICP-AES, % wt/wt |
|---|---|
| Sample | Si |
| Example1 | 1.95 |
| Example5 | 1.80 |
| Comparative Example1 | 0.05 |

As shown in Table 5, the separation membranes according to Examples 1 and 5 include POSS particles and Si in a relatively high concentration, unlike the separation membrane according to Comparative Example 1.

While various example embodiments are described herein, it is to be understood that the present disclosure is not limited to the disclosed embodiments, but, on the contrary, is intended to cover various modifications and equivalent arrangements included within the spirit and scope of the appended claims.

What is claimed is:

1. A semi-permeable film comprising:
a polyhedron oligomer silsesquioxane derivative dispersed in a polymer matrix, the polyhedron oligomer silsesquioxane derivative configured to permeate water and to exclude a salt.

2. The semi-permeable film of claim 1, wherein Si and O form a polyhedron lattice of the polyhedron oligomer silsesquioxane derivative, an atomic ratio of the Si to the O ranging from about 1:1 to about 1.5:1.

3. The semi-permeable film of claim 1, wherein the polyhedron oligomer silsesquioxane derivative is a pentahedron represented by Chemical Formula 1, a hexahedron represented by Chemical Formula 2, a heptahedron represented by Chemical Formula 3, an octahedron represented by Chemical Formula 4, an enneahedron represented by Chemical Formula 5, or a decahedron represented by Chemical Formula 6, the polyhedron oligomer silsesquioxane derivative being an open polyhedron where O in at least one —Si—O—Si— bond of Chemical Formulae 1 to 6 is substituted with a substituent and the at least one —Si—O—Si— bond is cleaved: 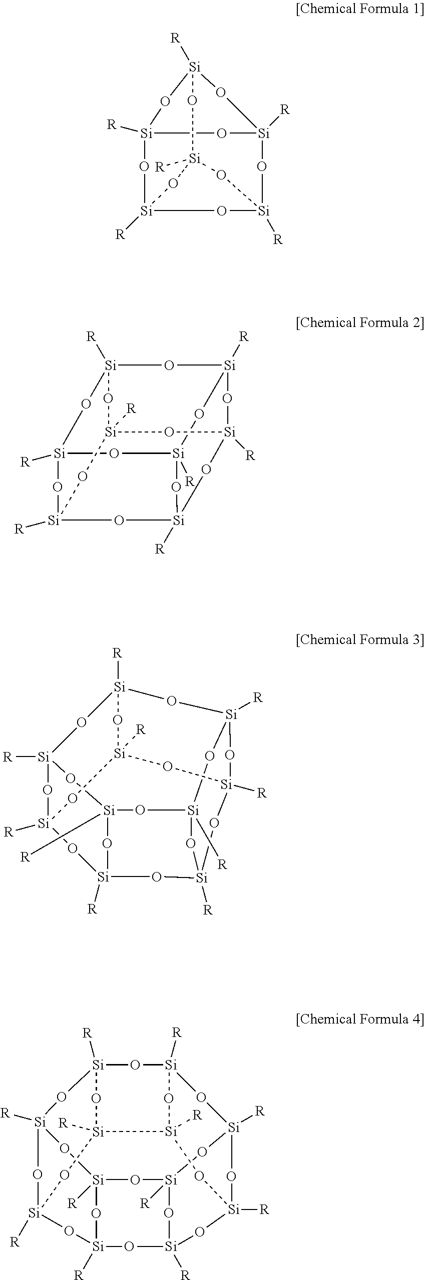 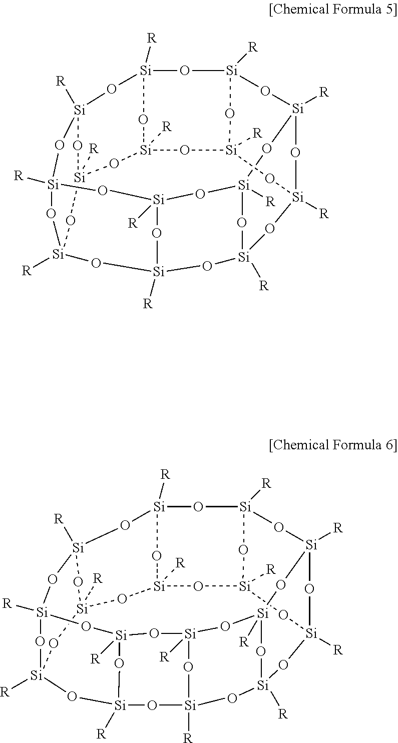
wherein R is independently an ionic functional group, a non-ionic functional group, an oligomer, a polymer, a functional group modified with an inorganic particle, or a combination thereof.

4. The semi-permeable film of claim 3, wherein the ionic functional group is an anionic functional group selected from —COO⁻, —CO₃⁻, —SO⁻₃, —SO₂⁻, —SO₂NH⁻, —NH₂⁻, —PO₃⁻², —PO₄⁻, —CH₂OPO₃⁻, —(CH₂O)₂PO₂⁻, —C₆H₄O⁻, —OSO₃⁻, —SO₂NR′⁻, —SO₂NSO₂R′⁻, —SO₂CRSO₂R″⁻, —AsO₃⁻, —SeO₃⁻ (wherein R′ and R″ are each independently a C1 to C4 alkyl group or a C7 to C10 arylalkyl group), —Cl⁻, —Br⁻, —SCN⁻, —ClO⁴⁻, and a combination thereof; a cationic functional group selected from an amino group, an ammonium group, a quaternary phosphonium group (—PR′″₄), a tertiary sulfonium group (—SR′″₃), a pyridinium group, a piperidine group, a pyrimidinium group, a pyrazolidine group, a piperazine group, and a combination thereof (wherein R′″ is a C1 to C4 alkyl or a C7 to C10 arylalkyl group); or a zwitterionic functional group selected from imidazolidine, betaine, and morpholine.

5. The semi-permeable film of claim 3, wherein the non-ionic functional group is selected from a substituted or unsubstituted C1-C30 alkyl, a substituted or unsubstituted C2-C30 alkenyl, a substituted or unsubstituted C2-C30 alkynyl, a substituted or unsubstituted C5 to C30 aryl, a substituted or unsubstituted C3-C30 cycloalkyl, a substituted or unsubstituted C1-C30 heterocycloalkyl, a substituted or unsubstituted C1-C30 heteroaryl, a substituted or unsubstituted C2-C30 alkylaryl, a substituted or unsubstituted C2-C30 arylalkyl, a substituted or unsubstituted C1-C30 alkoxy, a substituted or unsubstituted ester, a substituted or unsubstituted ether, and a combination thereof.

6. The semi-permeable film of claim 3, wherein the oligomer or polymer is a hydrophilic oligomer of alkylene oxide, vinyl alcohol, acrylonitrile, vinylpyrrolidone, lactic acid, epoxy, cellulose, (meth)acrylate, or alkyl(meth)acrylic acid, or a polymer thereof.

7. The semi-permeable film of claim 3, wherein the functional group modified with an inorganic particle is a C1 to C30 alkylsilyl group.

8. The semi-permeable film of claim 3, wherein the functional group is a tetramethyl ammonium (TMA) group or an isobutyl group.

9. The semi-permeable film of claim 1, wherein the polyhedron oligomer silsesquioxane derivative is in a form of a nano-particle including nano-pores having an average pore size of about 0.3 nm to about 3 nm.

10. The semi-permeable film of claim 1, wherein the polymer matrix comprises a polymer selected from polyamide, cross-linked polyamide, polyamide-hydrazide, poly(amide-imide), polyimide, poly(allylamine)hydrochloride/poly(sodium styrene sulfonate) (PAH/PSS), polybenzimidazole, sulfonated poly(arylene ether sulfone), and a combination thereof.

11. The semi-permeable film of claim 1, wherein the polyhedron oligomer silsesquioxane derivative is present in an amount ranging from about 0.01 to about 10 wt % based on a total weight of the polymer matrix.

12. A separation membrane comprising:
the semi-permeable film of claim 1; and
a porous support.

13. The separation membrane of claim 12, wherein the porous support comprises a polymer selected from a polysulfone-based polymer selected from polysulfone, polyethersulfone, and poly(ether sulfone ketone); a poly(meth)acrylonitrile polymer selected from polyacrylonitrile, and polymethacrylonitrile; a polyolefin-based polymer selected from polyethylene, polypropylene, and polystyrene; a polycarbonate; a polyalkylene terephthalate selected from polyethylene terephthalate, and polybutylene terephthalate; a polyimide-based polymer; a polybenzimidazole-based polymer; a polybenzthiazole-based polymer; a polybenzoxazole-based polymer; a polyepoxy-based polymer; a polyphenylenevinylene-based polymer; a polyamide-based polymer; a cellulose-based polymer; polyvinylidene fluoride (PVDF); polytetrafluoroethylene (PTFE); polyvinyl chloride (PVC); and a combination thereof.

14. The separation membrane of claim 12, wherein the semi-permeable film has a thickness of about 0.01 μm to about 100 μm.

15. The separation membrane of claim 12, wherein the porous support has a thickness of about 25 μm to about 250 μm.

16. A water treatment device comprising the separation membrane according to claim 12.

17. A method of manufacturing a semi-permeable film including a polyhedron oligomer silsesquioxane derivative dispersed in a polymer matrix, comprising:
preparing a first monomer solution for the polymer matrix, the first monomer solution including an aromatic polyamine or an aliphatic polyamine monomer;
preparing a second monomer solution for the polymer matrix, the second monomer solution including a multi-functional acylhalide;
adding the polyhedron oligomer silsesquioxane derivative to the first monomer solution, the second monomer solution, or both the first monomer solution and the second monomer solution; and
contacting the first monomer solution with the second monomer solution on a substrate to achieve interface polymerization.

18. The method of claim 17, wherein the adding includes the polyhedron oligomer silsesquioxane derivative being a pentahedron represented by Chemical Formula 1, a hexahedron represented by Chemical Formula 2, a heptahedron represented by Chemical Formula 3, an octahedron represented by Chemical Formula 4, an enneahedron represented by Chemical Formula 5, or a decahedron represented by Chemical Formula 6, the polyhedron oligomer silsesquioxane derivative being an open polyhedron where O in at least one —Si—O—Si— bond of Chemical Formulae 1 to 6 is substituted with a substituent and the at least one —Si—O—Si— bond is cleaved: 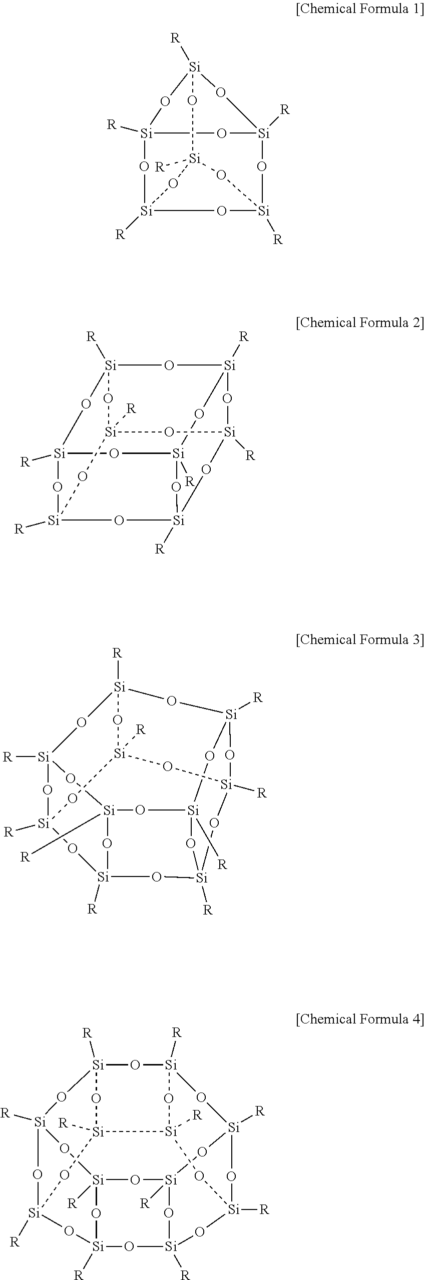 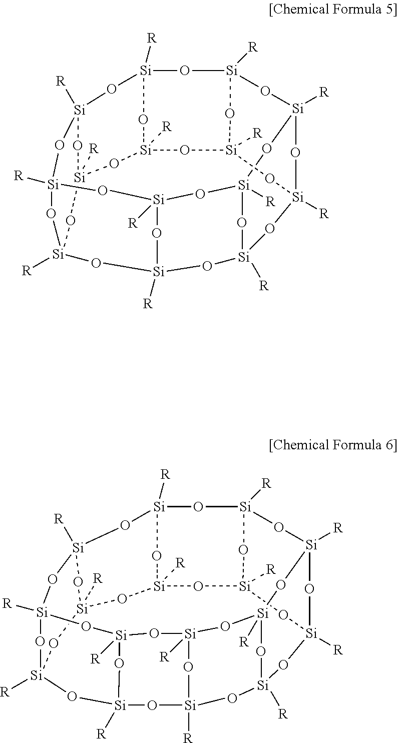
wherein R is independently an ionic functional group, a non-ionic functional group, an oligomer, a polymer, a functional group modified with an inorganic particle, or a combination thereof.

19. The method of claim 17, wherein a first monomer of the first monomer solution is an aromatic polyamine selected from diaminobenzene, triaminobenzene, m-phenylene diamine, p-phenylene diamine, 1,3,5-triaminobenzene, 1,3,4-triaminobenzene, 3,5-diaminobenzoic acid, 2,4-diaminotoluene, 2,4-diaminoanisole, xylene diamine, and a combination thereof, or an aliphatic polyamine selected from ethylene diamine, propylene diamine, piperazine, tris(2-diaminoethyl)amine), and a combination thereof.

20. The method of claim 17, wherein a second monomer of the second monomer solution is selected from trimesoyl chloride (TMC), trimellitic chloride, isophthaloyl chloride, terephthaloyl chloride, and a combination thereof.
